(19) United States
(12) Patent Application Publication
(10) Pub. No.: US 2014/0047772 A1
(43) Pub. Date: Feb. 20, 2014

(54) VEHICLE WINDOW ASSEMBLY WITH ARTICULATING PANEL

(71) Applicant: Michael J. Hulst, Holland, MI (US)

(72) Inventor: Michael J. Hulst, Holland, MI (US)

(73) Assignee: MAGNA MIRRORS OF AMERICA, INC., Holland, MI (US)

(21) Appl. No.: 14/113,413

(22) PCT Filed: Apr. 25, 2012
(86) PCT No.: PCT/US12/34916

§ 371 Date: Oct. 23, 2013

Related U.S. Application Data
(60) Provisional application No. 61/479,582, filed on Apr. 27, 2011.
(60) Provisional application No. 61/568,289, filed on Dec. 8, 2011.

(51) Int. Cl. B60J 1/14; B60J 1/20

(52) U.S. Cl. CPC B60J 1/14; B60J 1/20
USPC 49/383; 49/394; 49/388

(57) ABSTRACT

A window assembly for a vehicle includes a fixed window panel having an aperture formed therethrough and a movable window panel that is articulatably attached at the fixed window panel and is articulatable between a closed position, where the movable window panel is disposed in the aperture and is substantially coplanar with the fixed window panel, and an opened position, where at least a portion of the movable window panel is moved outward from the aperture. The movable window panel is attacked at the fixed window panel via at least one hinge element at a first perimeter region of the movable window panel and a latch element at a second perimeter region of the movable window panel, with the second perimeter region being opposite the first perimeter region.

### CROSS REFERENCE TO RELATED APPLICATIONS

The present application claims the filing benefits of U.S. provisional applications, Ser. No. 61/568,289, filed Dec. 8, 2011; and Ser. No. 61/479,582, filed Apr. 27, 2011, which are hereby incorporated herein by reference in their entireties.

### FIELD OF THE INVENTION

The present invention relates to movable or openable window assemblies for vehicles and, more particularly to a vehicle window assembly with an articulating window panel.

### BACKGROUND OF THE INVENTION

It is known to provide a window assembly for an opening of a vehicle, such as a side window assembly for a side opening of a vehicle such as a van or the like. Conventional side window assemblies for side openings of trucks or the like may have a slidable window panel or may have a window panel that is articulatably mounted to the sheet metal of the vehicle.

### SUMMARY OF THE INVENTION

The present invention provides a vehicle window assembly that has a flip out window panel that is pivotally or articulatably attached at a fixed window panel and that is disposed at an aperture formed through the fixed window panel.

According to an aspect of the present invention, a window assembly for a vehicle comprises a fixed window panel having an aperture formed therethrough and a movable window panel that is articulatably attached at the fixed window panel and is articulatable between a closed position, where the movable window panel is disposed in the aperture and is substantially coplanar with the fixed window panel, and an opened position, where at least a portion of the movable window panel is moved outward from the aperture. The movable window panel is attached at the fixed window panel via at least one hinge element at a first perimeter region of the movable window panel and a latch element at a second perimeter region of the movable window panel, with the second perimeter region opposite the first perimeter region,

Optionally, the movable window panel may be articulatable about a generally vertical pivot axis when the window assembly is normally mounted in a vehicle. The at least one hinge element (such as a pair of spaced apart vertically offset hinge elements) may be attached at a leading perimeter region of the movable window panel and the latch element may be attached at a trailing perimeter region of the movable window panel.

Optionally, the hinge element and/or the latch element may be attached to the fixed window panel via at least one frame portion attached to the fixed window panel. The frame portion may be bonded to an inner surface of said fixed window panel, or may be bolted or otherwise attached at the fixed window panel. Optionally, the frame portion may comprise a circumferential frame that is disposed around the aperture in the fixed window panel. The frame portion may include a sealing element that seals against an inner surface of the movable window panel when the movable window panel is in the closed position. An outer surface of the movable window panel may be substantially coplanar with an outer surface of the fixed window panel when the movable window panel is in the closed position.

These and other objects, advantages, purposes and features of the present invention will become apparent upon review of the following specification in conjunction with the drawings.

### BRIEF DESCRIPTION OF THE DRAWINGS

FIG. 1 is a perspective view of a window assembly in accordance with the present invention, shown from the outside of the vehicle;

FIG. 2 is a perspective view of the window assembly of FIG. 1, shown from inside the vehicle with the interior trim of the vehicle removed;

FIG. 3 is a perspective view of the window assembly of FIG. 1, shown from inside the vehicle with the interior trim of the vehicle installed;

FIG. 4 is another inner perspective view of the window assembly of FIG. 1;

FIG. 5 is a sectional view of the window assembly taken along the line V-V in FIG. 4;

FIG. 5A is a sectional view similar to FIG. 5 of an optional configuration for the window assembly of the present invention;

FIG. 5B is a sectional view similar to FIG. 5 of another optional configuration for the window assembly of the present invention;

FIG. 6 is a sectional view of the window assembly taken along the line VI-VI in FIG. 4;

FIG. 6A is a sectional view similar to FIG. 6 of an optional configuration for the window assembly of the present invention;

FIG. 7 is a sectional view of the window assembly taken along the line VII-VII in FIG. 4;

FIG. 7A is a sectional view similar to FIG. 7 of an optional configuration for the window assembly of the present invention;

FIG. 8 is a sectional view of the window assembly taken along the line VIII-VIII in FIG. 4;

FIG. 8A is a sectional view similar to FIG. 8 of an optional configuration for the window assembly of the present invention;

FIG. 9 is a sectional view of the window assembly taken along the line IX-IX in FIG. 4;

FIG. 9A is a sectional view similar to FIG. 9 of an optional configuration for the window assembly of the present invention;

FIG. 10 is a perspective view of another window assembly in accordance with the present invention;

FIG. 11 is a sectional view of the window assembly taken along the line XI-XI in FIG. 10;

FIG. 12 is a perspective view of another window assembly of the present invention, shown from inside the vehicle with the interior trim of the vehicle installed;

FIG. 13 is a perspective view of the window assembly of FIG. 12, as viewed from outside of the vehicle;

FIG. 14 is a perspective view of a hinge of the window assembly of FIG. 12;

FIG. 15 is another perspective view of the hinge of FIG. 14, shown with the cover element removed;

FIG. 16 is a sectional view of the hinge of FIG. 14;

FIG. 17 is a sectional view of the window assembly taken along the line XVII-XVII in FIG. 12;

FIG. 18 is a perspective view of the latch mechanism of the window assembly of FIGS. 12 and 13; and

FIG. 19 is a plan view of another window assembly of the present invention, shown with frame elements that support a frame portion of the fixed window and that attach to the vehicle when the window assembly is mounted to the vehicle.

### DESCRIPTION OF THE PREFERRED EMBODIMENTS

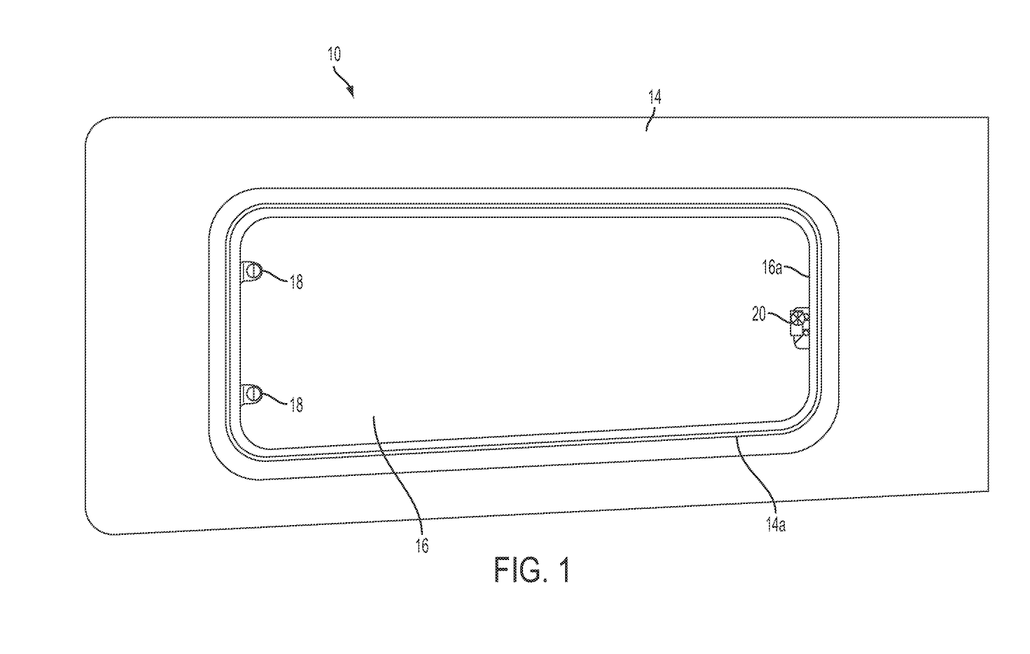

Referring now to the drawings and the illustrative embodiments depicted therein, a window assembly 10 of a vehicle includes a fixed window panel 14 and an articulatable or flip-out window panel 16 pivotally mounted at an opening 14a of fixed window panel 14 (FIGS. 1-4). Fixed window panel 14 may be adhered or otherwise mounted or attached or bonded to the sheet metal of a vehicle, such as at an opening formed at a side of a vehicle, such as a van or mini-van or transit van or the like. Flip-out window panel 16 is movable or articulatable relative to fixed window panel 14 between a closed position, where the flip-out window panel is disposed at and within the opening 14a of fixed window panel 14 and substantially sealed relative to fixed window panel 14, and an opened position, where the flip-out window panel is articulated (such as about one or more hinges or mounting elements 18) so as to have one end region 16a (such as a rear end region when the window assembly is mounted at the vehicle) moved outwardly relative to the fixed window panel 14, as discussed below. The rear end region 16a of flip-out window panel 16 may be movably connected to the fixed window panel 14 (or to a mounting base or element or frame 22 disposed about the periphery of the window aperture 14a and at or along an inner surface of the fixed window panel) via a latch mechanism or element 20, while the front end region 16b of flip-out window panel 16 may be pivotally mounted or connected at the fixed window panel 14 (or to the mounting base or element or frame 22 disposed about the periphery of the window aperture 14a and at or along the inner surface of the fixed window panel) via a pair of hinge elements 18, as also discussed below.

In the illustrated embodiment, fixed window panel 14 comprises a single window panel (such as a glass window panel or tempered glass window panel or such as a polycarbonate panel or the like) with an aperture 14a (such as a rectangular aperture or the like) formed or established therethrough. The fixed window panel 14 may be attached to the vehicle sheet metal to mount the window assembly to the vehicle, such as via a urethane adhesive 15 or the like, and optionally may include a perimeter frame around its periphery for attaching the fixed window panel and window assembly to the vehicle. The fixed window panel 14 may have a light absorbing coating or layer, such as a substantially opaque ceramic frit layer or the like, disposed about the periphery of the aperture 14a to conceal or hide the frame 22 from view by a person viewing the window assembly from outside of the vehicle, and the light absorbing coating or layer or frit layer may be disposed substantially at the inner surface of the fixed window panel to conceal the adhesive 15 and the vehicle trim components 12 (FIG. 3) from view by a person viewing the window assembly from outside of the vehicle. The movable window panel 16 may also have a light absorbing coating or layer, such as a substantially opaque ceramic fit layer or the like, disposed about the periphery of the panel to conceal or hide the sealing element (discussed below) and hinge elements and latch element from view by a person viewing the window assembly from outside of the vehicle.

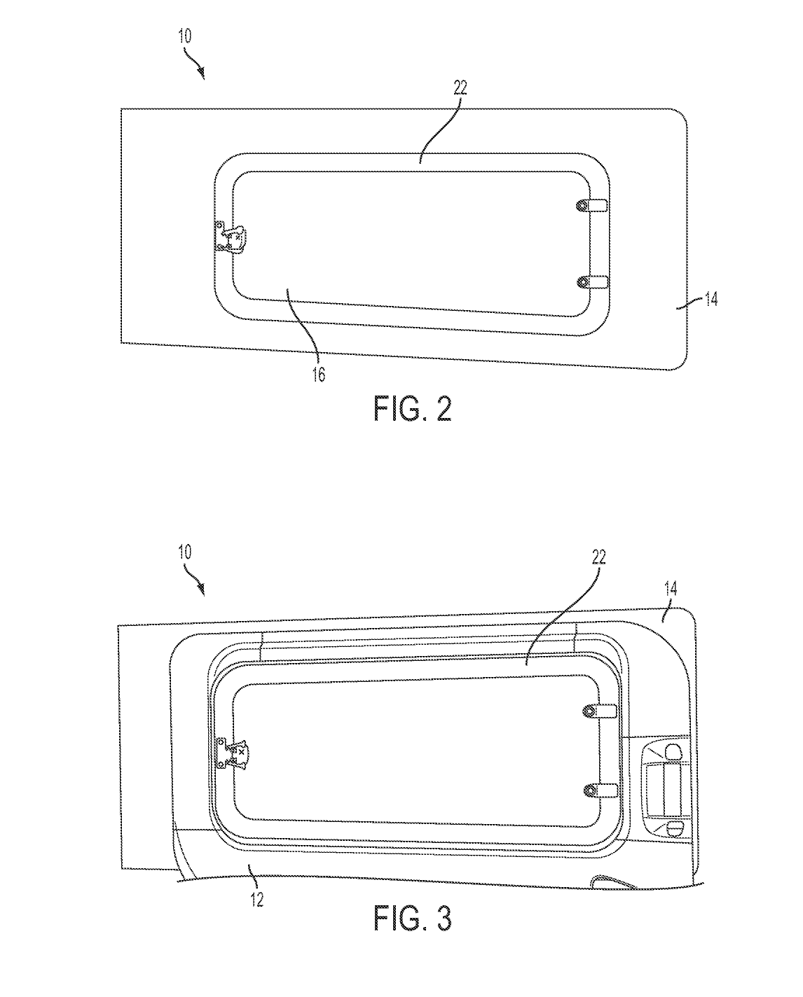

As shown in FIGS. 2 and 3, a pair of hinges or hinge elements 18 are mounted to the fixed window panel 14 adjacent to the opening or aperture 14a and inboard of a leading edge or end 14b of fixed window panel 14 and are mounted to the movable window panel 16 at the leading edge or end 16b of the movable window panel 16. Similarly, the latch mechanism or element 20 is mounted to the fixed window panel 14 adjacent to the opening or aperture 14a and inboard of a trailing edge or end 14c of fixed window panel 14, and is mounted to the movable window panel 16 at the trailing edge or end 16a of the movable window panel 16. In the illustrated embodiment, frame 22 is attached to fixed window panel 14 and disposed about the periphery of the opening or aperture 14a, and the hinge elements 18 and latch element 20 are mounted to or established at the frame 22, as discussed below.

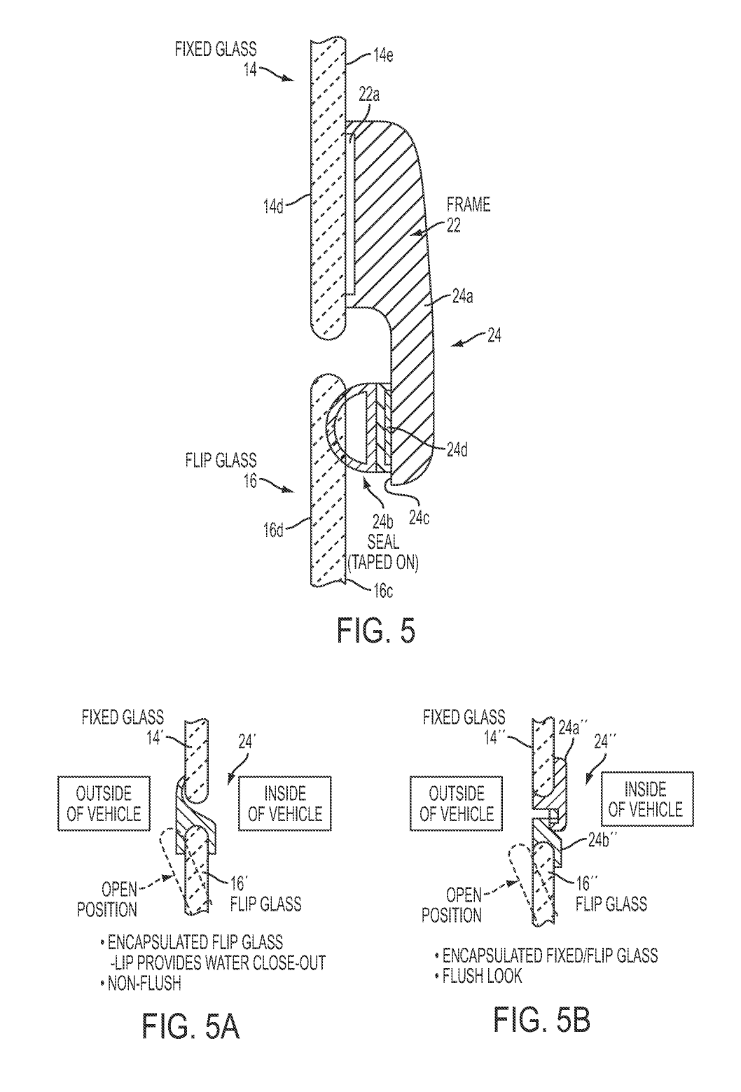

When in its closed position, the flip-out or movable window panel 16 is sealed or substantially sealed about its perimeter relative to the fixed window panel 14 via a perimeter seal or sealing element or assembly 24. As shown in FIG. 5, sealing element 24 includes a frame portion 24a that extends from frame 22 (and may be integrally formed therewith) and extends partially into or over the aperture 14a. Seal 24 includes a sealing element 24b (such as a flexible bulb seal or Y-seal or the like) disposed along an outboard or exterior facing surface 24c of frame portion 24a. The sealing element 24b may be attached to frame portion 24a via any suitable means, such as adhesive or tape 24d or the like, and protrudes towards the plane of the opening or aperture 14a so as to contact an inner surface 16c of movable window panel 16 when the window panel 16 is in its closed position (so as to be generally coplanar with the aperture 14a and fixed window panel 14, such as shown in FIG. 5). With such a sealing configuration, the outer surface 16d of movable window panel 16 is generally flush or coplanar with the outer surface 14d of fixed window panel 14 when the movable window panel is closed.

Optionally, other means for sealing the movable window panel about its periphery relative to the fixed window panel may be implemented, while remaining within the spirit and scope of the present invention. For example, and with reference to FIG. 5A, a lip seal 24′ may be formed or disposed at and along and around the perimeter edge of the movable window panel 16′ (and may encapsulate the perimeter edge of the window panel 16′), with the lip seal 24′ extending towards and onto the fixed window panel 14′ so as to contact an exterior or outer surface 14d′ of the fixed window panel 14′ when the movable window panel 16′ is closed. Optionally, and with reference to FIG, 5B, a seal 24″ may comprise a fixed panel sealing portion 24a″ attached to or established at the fixed window panel 14″ and a movable panel sealing portion 24b″ attached to or established at the perimeter edge of the movable window panel 16″. As shown in FIG. 5B, the sealing portions 24a″, 24b″ include sealing elements, such as flexible sealing elements or the like, that engage one other at a gap between the perimeter edge of the movable window panel and the perimeter edge of the fixed window panel at the aperture when the movable window panel is closed.

As shown in FIGS. 5-7 and 9, the seal 24 extends along the frame 22 and around the periphery of the aperture 14a of fixed window panel 14, so as to seal against the inner surface 16c of movable window panel 16 about the periphery of the movable window panel 16 when the window is closed. In the illustrated embodiment, the sealing frame portion 24a is integrally formed or molded with the frame 22, and the frame 22 is attached to (such as via bonding) the inner surface 14e of fixed window panel 14. For example, the frame 22 may include a recess 22a at its surface facing the inner surface 14e of fixed window panel 14 for receiving a selected or desired or appropriate amount of adhesive therein for adhering or bonding the frame 22 to the inner surface 14e of fixed window panel 14. Optionally, the recess may be established to provide the desired bond line thickness of the adhesive, or the frame 22 may otherwise include protrusions or spacers or the like to establish the desired bond line thickness of the adhesive, such as by utilizing aspects of the window assemblies described in U.S. Pat. Nos. 7,838,115; 7,332,225; 6,846,039; 6,319,344; 6,068,719; 5,853,895; 7,588,652; 7,360,338; 6,871,450; 6,298,606; 6,128,860; 5,966,874; 5,704,173; 5,551,197, which are hereby incorporated herein by reference in their entireties. The frame may comprise any suitable materials, and may be formed or molded out of a plastic or polymeric material (such as a polycarbonate or an ABS or PET material) or the like.

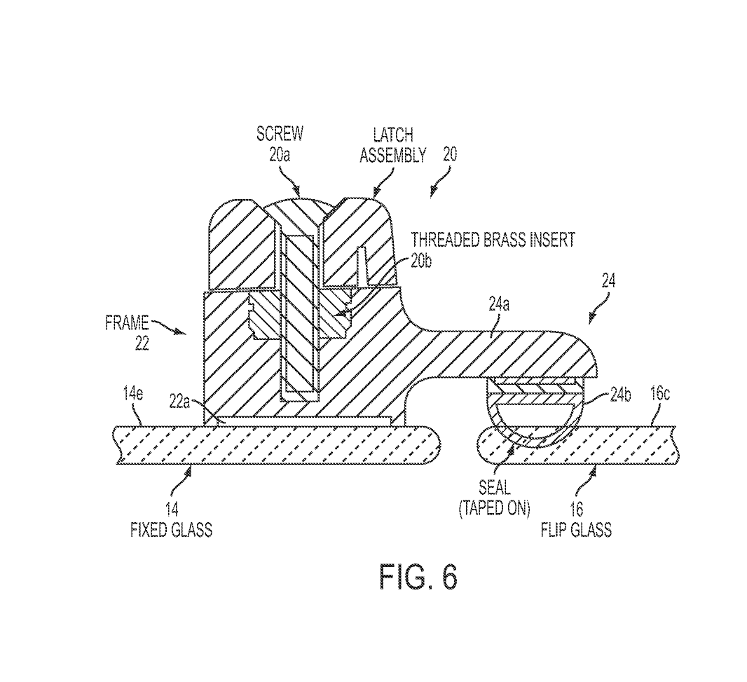

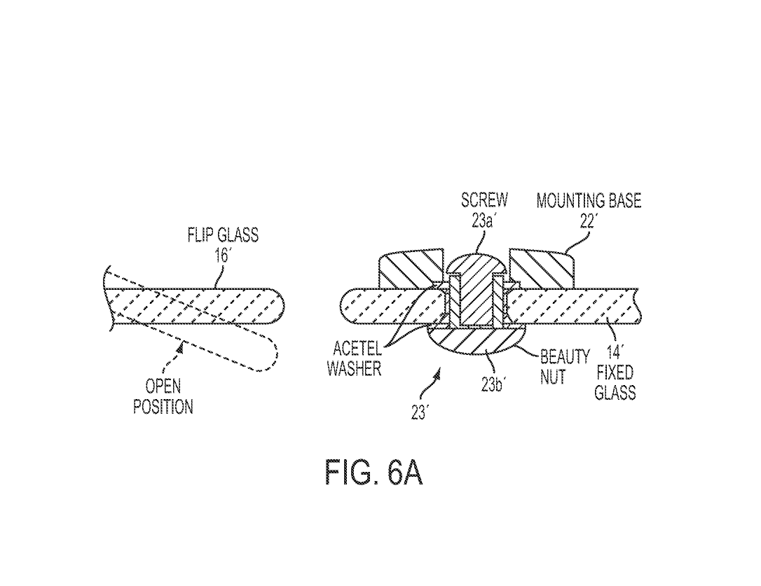

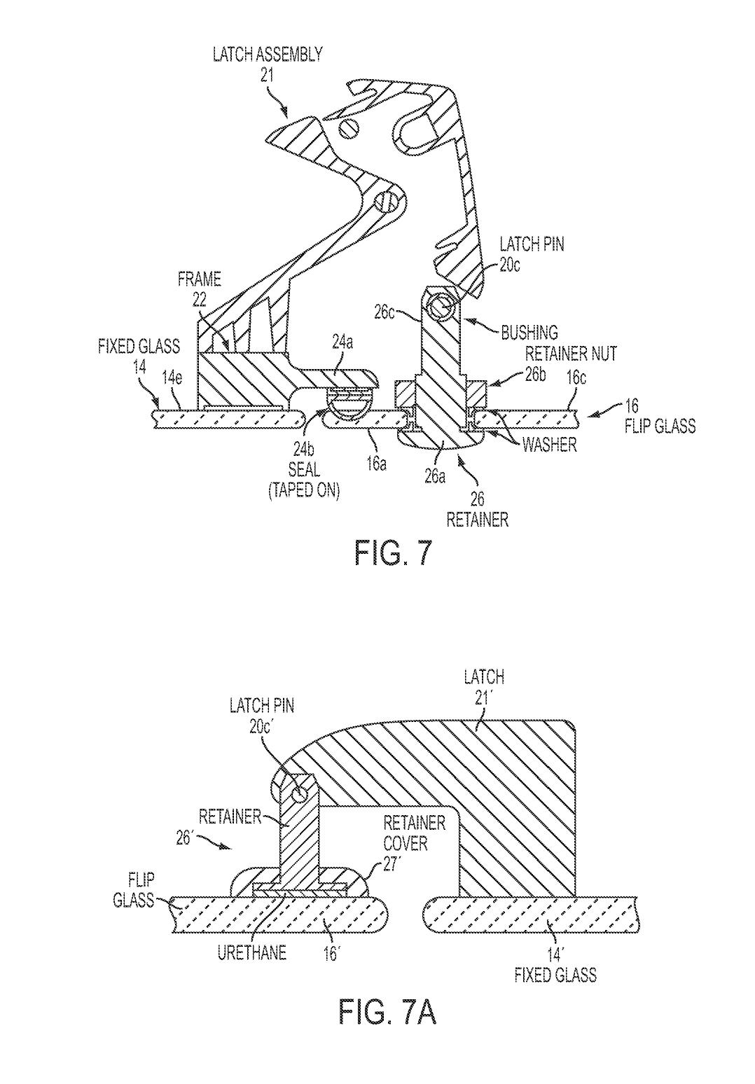

As shown in FIGS. 6 and 7, the latch or latch element or mechanism 20 is attached at or established at the frame 22 (such as via threaded fasteners 20a or the like received in threaded inserts 20b or the like at the frame 22), and includes an articulating latch assembly 21 that pivots and articulates to move the trailing edge 16a of the movable window panel 16 relative to the fixed window panel 14. The latch assembly 21 is attached at a retainer or mounting portion 26 attached at or near the trailing edge or end region 16a of movable window panel 16. In the illustrated embodiment, the latch assembly 21 is attached at retainer 26 via a latch pin 20c so as to pivotally attach the latch assembly 21 at the movable window panel 16. Retainer 26 may be attached to the movable window panel 16 via any suitable means, and may be adhered or bonded at the inner surface 16c of movable window panel 16, or, and such as shown in FIG. 7, retainer 26 may comprise a pin or bolt or stud 26a that is received through an opening in the movable window panel 16 and that is secured relative to the movable window panel 16 via a retainer nut 26b or the like, with a stud portion 26c protruding from movable window panel 16 for attachment to the latch assembly 21 via latch pin 20c. The latch or latch assembly may comprise any suitable window latching or window actuating device or assembly, and may comprise overcenter hinges and may be manually actuated or electrically actuated to pivot the window between its opened and closed positions, and optionally may include an electrically actuated actuator or a pneumatic actuator or a cable actuator or the like to provide powered window opening and closing capabilities, such as by utilizing aspects of the window assemblies described in U.S. Pat. Nos. 7,588,652; 7,360,338; 6,871,450; 6,298,606; 6,128,860; 5,966,874; 5,704,173; and 5,551,197, which are hereby incorporated herein by reference in their entireties.

Optionally, and with reference to FIG. 7A, the retainer 26′ may be adhered or bonded to the inner surface 16c′ of the movable window panel 16′, such as via an adhesive or the like, and optionally, the base of the retainer may be covered or concealed via a retainer cover 27′ or the like, with the pin or stud portion 26c′ protruding from the cover 27′ for attachment to the latch assembly 21′ via latch pin 20c′. Optionally, the frame, such as at or near the latch (or elsewhere around the periphery of aperture of fixed window panel) may be bolted or otherwise attached to the fixed window panel. For example, and such as shown in FIG. 6A, a fastener 23′ may be received through an aperture or hole in the fixed window panel 14′ and may attach the mounting base of the frame 22′ to the fixed window panel 14′ (such as via a male fastener or screw 23a′ being threadedly received in and secured to a female fastener or nut 23b′, with washers or the like at the opposite surfaces of the window panel to secure the fastener and mounting frame relative to the fixed window panel).

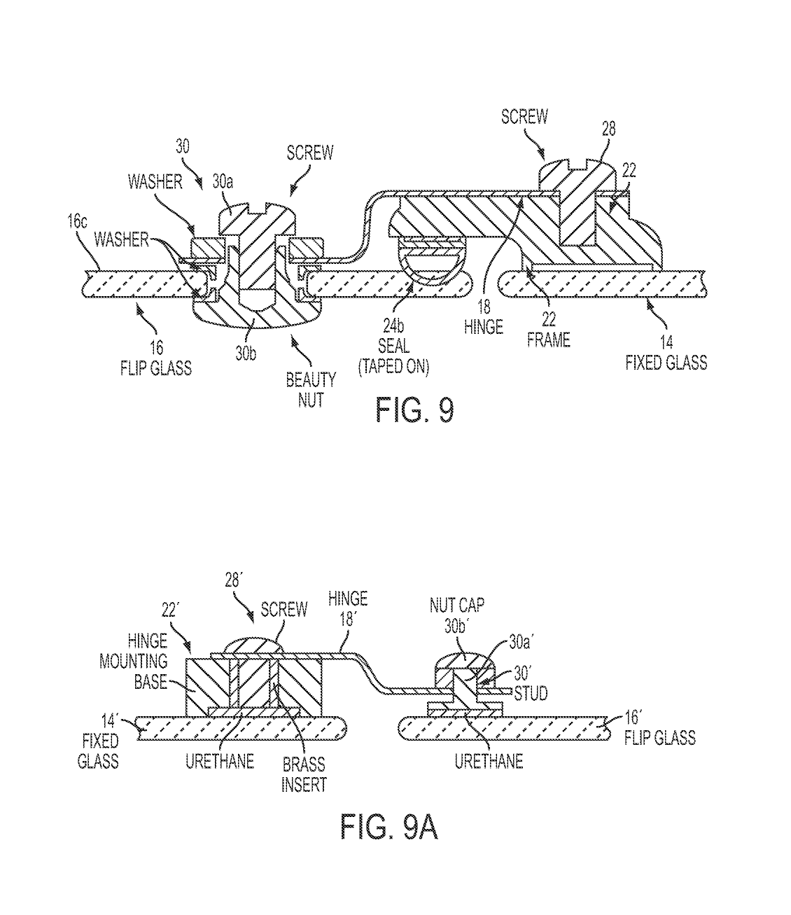

Referring now to FIG. 9, the leading edge 16b of movable window panel 16 is pivotally or articulatably attached or mounted at fixed window panel 14 (such as at frame 22) via hinge elements 18. In the illustrated embodiment, hinge 18 comprises a flexible metallic element that is attached at one end to frame 22 via a fastener or screw or bolt 28 and at the other end to movable window panel 16 via another fastener or screw or bolt 30. The fastener 30 may comprise a male fastener or screw 30a that is threadedly received in and secured to a female fastener or nut 30b, with washers or the like at the opposite surfaces of the window panel to secure the fastener and hinge element relative to the movable window panel 16. Optionally, and with reference to FIG. 9A, the hinge 18′ may be adhered or bonded to the fixed window panel 14′ and/or the movable window panel 16′. For example, and as shown in FIG. 9A, one end of the hinge element 18′ may be attached at the frame 22′ via a fastener 28′, with the frame 22′ being adhered or bonded to the fixed window panel 14′, such as discussed above, and the other end of the hinge element 18′ may be attached to a fastener or stud 30′, such as via a female fastener or nut 30b′ threaded onto a threaded end 30a′ of the stud 30′, which is adhered or bonded to the inner surface 16c′ of movable window panel 16′ in a similar manner.

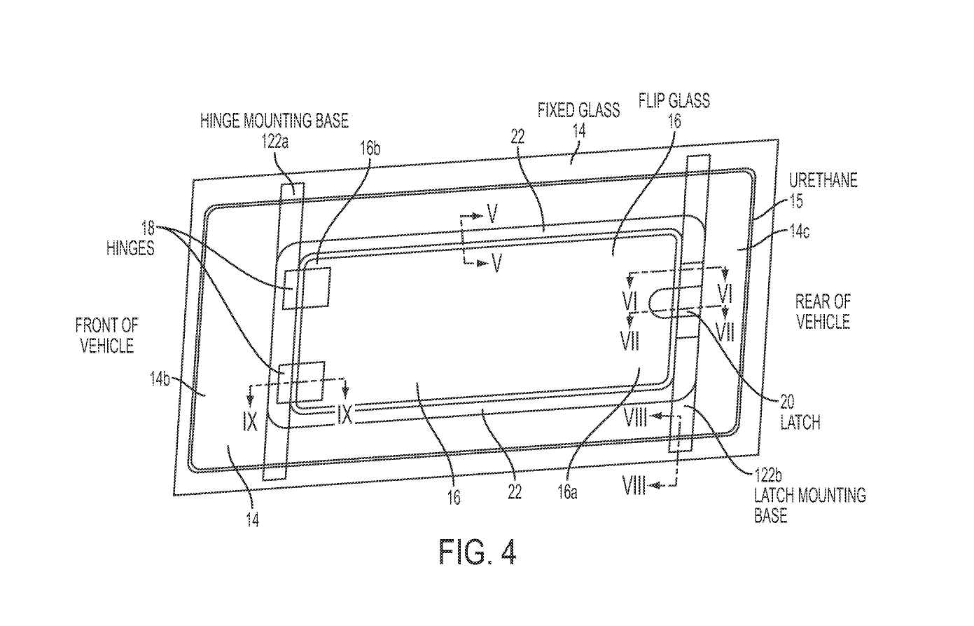

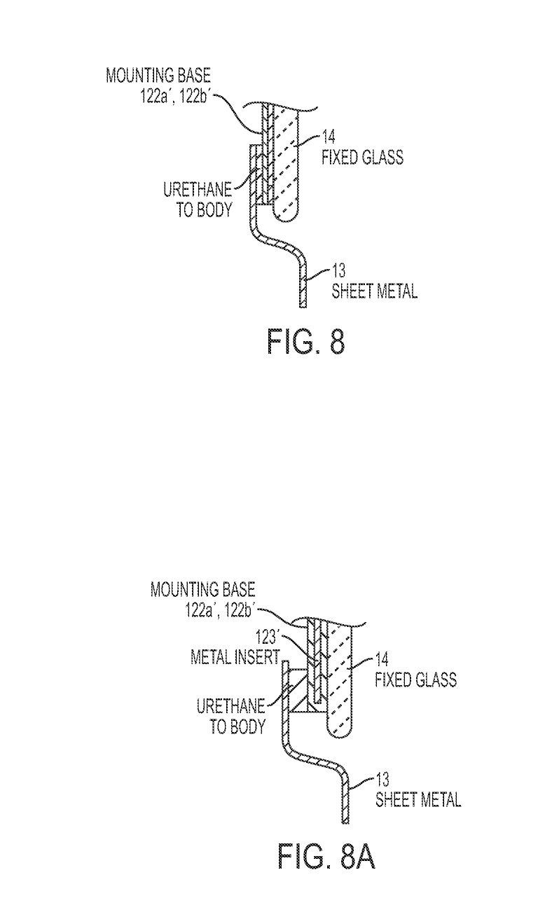

Optionally, and with reference to FIG. 4, instead of the frame extending around the periphery of the aperture 14a of fixed window panel 14, a generally vertical hinge mounting frame portion or base 122a may be disposed along the inner surface of the fixed window panel for supporting the hinge elements 18 thereat, while a generally vertical latch mounting frame portion or base 122b may be disposed along the inner surface of the fixed window panel for supporting the latch element thereat. As shown in FIG. 8, the mounting base 122a, 122b may extend toward the perimeter of the fixed window panel and may be adhered or bonded or attached to the sheet metal 13 of the vehicle, such as via an adhesive or the like. The mounting bases 122a, 122b may comprise any suitable material, such as a plastic or other suitable polymeric material (such as a polycarbonate or an ABS or PET material) or the like. Optionally, and with reference to FIG. 8A, the mounting bases 122a′, 122b′ may include a metallic insert 123′ disposed therein to enhance the structural rigidity of the elongated vertically oriented mounting bases. Optionally, the generally vertical mounting bases 122a, 122b may be in addition to the peripheral frame 22 that extends along the periphery of the window opening or aperture, and thus the mounting bases may anchor or tether the peripheral frame 22 relative to the vehicle when the window assembly is mounted to the vehicle, thereby providing enhanced attachment or securement of the frame 22 relative to the vehicle when the window assembly is mounted to the vehicle.

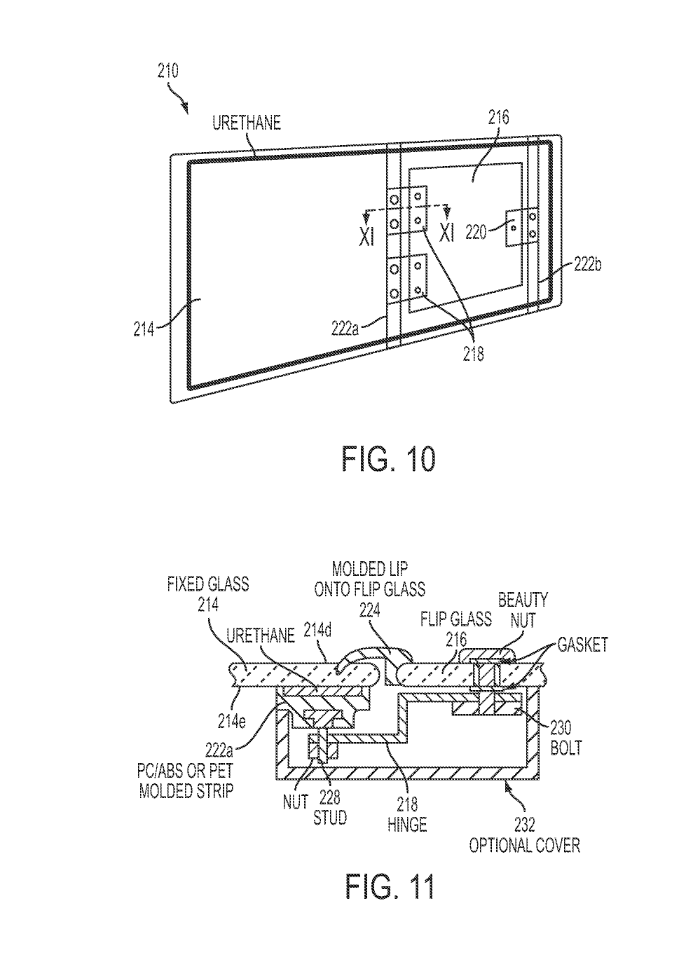

Optionally, the window assembly may comprise an elongated side fixed window panel with a substantially smaller flip out or movable window panel. For example, and with reference to FIGS. 10 and 11, a window assembly 210 includes a fixed window panel 214 and a flip out window panel 216 that is pivotally mounted at the fixed window panel 214 via a pair of hinge elements 218 and a latch 220, such as in a similar manner as described above. As shown in FIGS. 10 and 11, the hinge elements 218 and latch 220 may be mounted to generally vertically oriented mounting bases 222a, 222b, respectively, which may be attached along the inner surface of the fixed window panel 214 and/or may be attached at the vehicle sheet metal, such as described above. For example, and as shown in FIG. 11, the polymeric mounting base 222a may be adhered or bonded along the inner surface 214e of fixed window panel 214, and the hinge element 218 may be attached at one end to the mounting base 222a, such as via a stud or fastener 228. The other end of the hinge element 218 may be attached to the movable window panel 216 via another fastener 230 (such as a bolt and nut secured through the movable window panel as shown in FIG. 11, or such as a stud adhered or bonded to the inner surface of the movable window panel). The movable window panel includes a sealing element 224 at its perimeter edges, and may have the sealing element molded over the perimeter edge to attach the sealing element at the movable window panel and to encapsulate the perimeter edge of the movable widow panel. As shown in FIG. 11, the sealing element spans the gap between the movable window panel and the fixed window panel and engages and seals against the outer surface 214d of the fixed window panel 214 when the movable window panel is closed. Optionally, the hinge elements 218 and mounting base 222a may be encased or housed or covered by a cover element 232 that attaches to the window assembly or to the vehicle trim or sheet metal to conceal the hinge elements and mounting base from view by a person viewing the window assembly from inside the vehicle. Optionally, the fixed window panel and/or the movable window panel may have a light absorbing coating or layer, such as a substantially opaque ceramic frit layer or the like, disposed thereat to conceal or hide the sealing element, mounting bases, hinge elements and latch element from view by a person viewing the window assembly from outside of the vehicle.

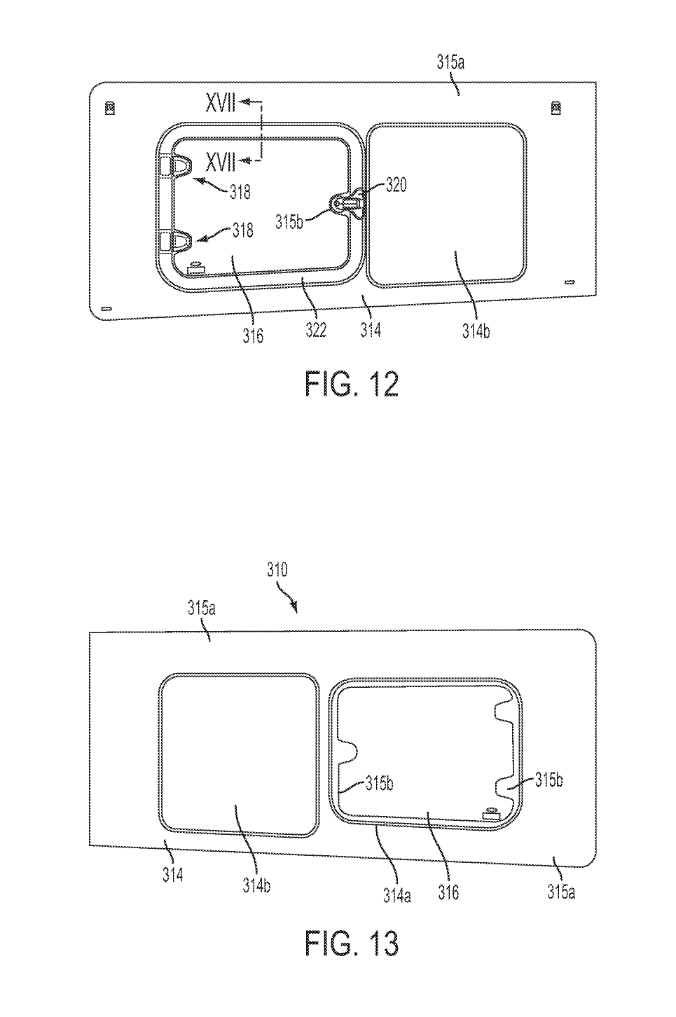

Optionally, and with reference to FIGS. 12-18, a window assembly 310 may include a fixed window panel 314 and a movable or flip out window panel 316 that is pivotally mounted at the fixed window panel 314 via a pair of hinge elements 318 and a latch 320, such as in a similar manner as described above. As shown in FIGS. 10 and 11, the hinge elements 318 are mounted to the fixed panel 314 and the flip out or movable panel 316 and are vertically spaced apart at a pivoting portion of the window panel. The latch or latch element or mechanism 320 is also mounted to the fixed panel 314 and the movable panel 316 at an opposite end or region of the movable panel 316 from the hinge elements 318. The hinge elements 318 and latch 320 are bonded to the window panels 314, 316, and a cover element or trim element or frame 322 is bonded to the fixed window panel 314 around the opening or aperture 314a of the fixed window panel 314 at which the flip out window panel 316 is disposed.

As shown in FIG. 12, the pair of hinges or hinge elements 318 are mounted to the fixed window panel 314 adjacent to the opening or aperture 314a and inboard of a leading edge or end of fixed window panel 314 and are mounted to the movable window panel 316 at the leading edge or end of the movable window panel 316. Similarly, the latch mechanism or element 320 is mounted to the fixed window panel 314 adjacent to the opening or aperture 314a and inboard of a trailing edge or end of fixed window panel 314, and is mounted to the movable window panel 316 at the trailing edge or end of the movable window panel 316. In the illustrated embodiment, frame 322 is attached to fixed window panel 314 and disposed about the periphery of the opening or aperture 314a, and the hinge elements 318 and latch element 320 are mounted to or established at window panels 314, 316 and frame 322, as discussed below.

The fixed window panel 314 may have a light absorbing coating or layer 315a (FIGS. 12 and 13), such as a substantially opaque ceramic frit layer or the like, disposed about the periphery of the aperture 314a to conceal or hide the frame 322 from view by a person viewing the window assembly from outside of the vehicle, and the light absorbing coating or layer or frit layer may be disposed substantially at the inner surface of the fixed window panel to conceal the adhesive and any vehicle trim components from view by a person viewing the window assembly from outside of the vehicle. As can be seen in FIGS. 12 and 13, the opaque coating 315a may be established around a transparent or light transmitting portion 314b of the fixed panel 314 to provide a fixed transparent window portion of the window assembly (that is generally adjacent to the movable or flip out panel 316), whereby the opaque coating 315a substantially hides or conceals the inner vehicle trim and attachment structures of the vehicle from view by a person viewing the window assembly from outside of the vehicle. The movable window panel 316 may also have a light absorbing coating or layer 315b (FIGS. 12 and 13), such as a substantially opaque ceramic frit layer or the like, disposed about the periphery of the panel to conceal or hide the sealing element (discussed below) and hinge elements and latch element from view by a person viewing the window assembly from outside of the vehicle.

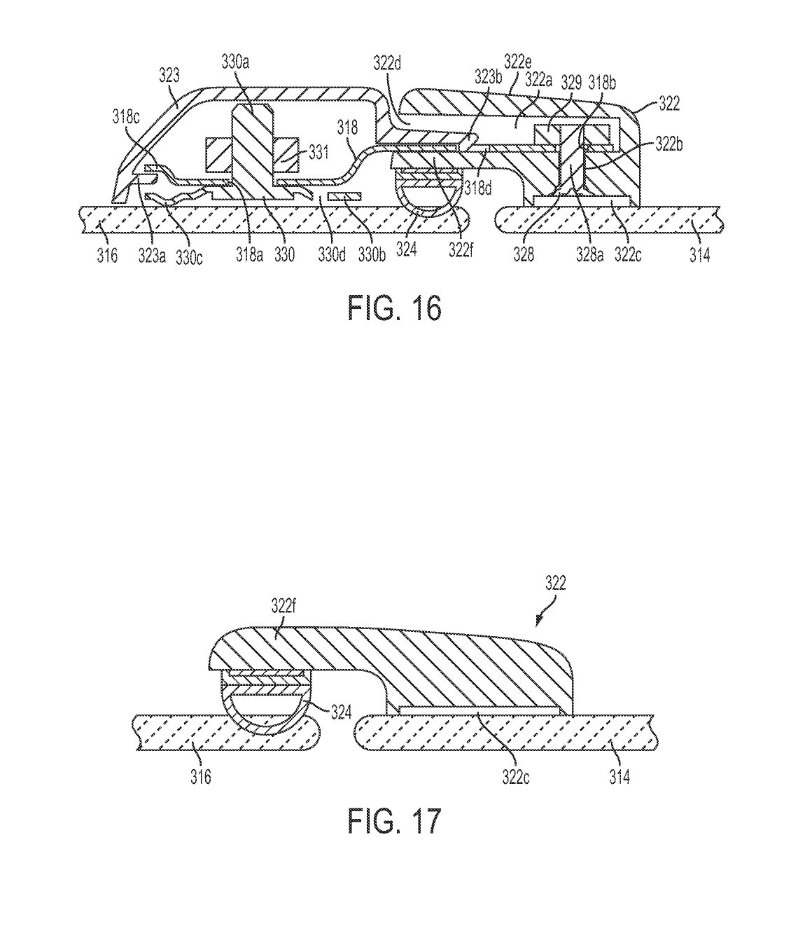

As shown in FIGS. 15 and 16, each hinge 318 comprises a bent or curved flexible metallic element that is attached at one end to a fastener or stud 328 at the cover element or frame 322 at the fixed panel 314 and at the other end to a fastener or stud 330 bonded to the flip out panel 316. The hinge element 318 is attached at a threaded portion 330a of stud 330 (which is received through an aperture or hole 318a established through the hinge element) via a female fastener or nut 331, and is attached at a threaded portion 328a of fastener 328 (which is received through an aperture or hole 318b established through the hinge element) via a female fastener or nut 329.

The fastener or stud 330 at flip out panel 316 includes a threaded shaft 330a and a bonding or attaching portion or flange 330b that is bonded to the flip out panel 316 via a suitable adhesive. Attaching flange 330b of stud 330 may include protrusions or projections 330c that function to establish the appropriate bond line thickness of the adhesive and/or attaching flange 330b of stud 330 may include holes or apertures 330d to enhance adhesion and securement of the flange to the panel (such as via utilizing aspects of the window assemblies described in U.S. Pat. Nos. 5,853,895 and 5,551,197, which are hereby incorporated herein by reference in their entireties).

In the illustrated embodiment, and as shown in FIG. 16, fastener 328 is disposed in the frame portion 322 and is received through the aperture or hole 318b of hinge element 318 and is threadedly received in a weld nut 329 or the like that may be welded or secured to the hinge element 318. Thus, during assembly of the window assembly, the hinge element 318 and weld nut 329 may be received into a slot or opening 322a of frame portion 322, whereby, when the threaded passageway of the weld nut is aligned with a passageway 322b for the fastener 328, the fastener 328 may be threaded into the weld nut 329 and tightened to secure the hinge element relative to the frame portion 322. The frame portion 322 (with hinge elements 318 attached thereto) may then be adhered or bonded to the surface of the fixed panel 314, such as via any suitable adhesive. As shown in FIG. 16, the frame portion 322 includes a recess or channel 322c at an attaching portion of the frame portion for receiving adhesive therein to bond the frame portion 322 to the fixed panel.

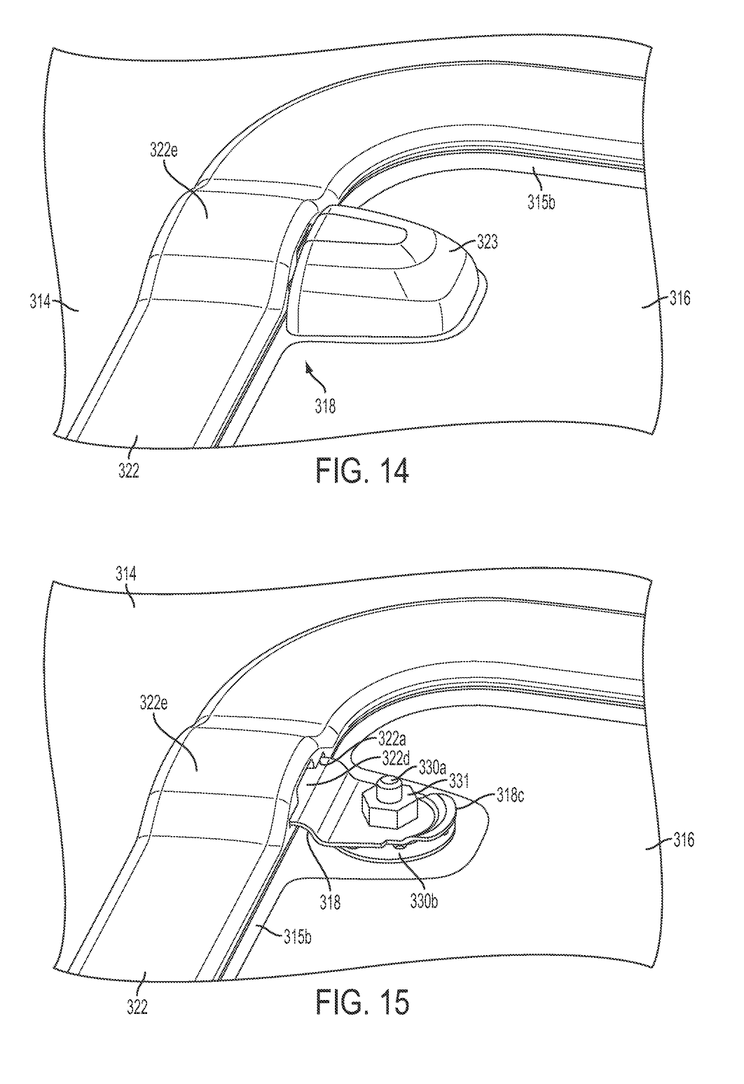

After the frame portion 322 and hinge elements 318 are attached at the fixed panel 314, the movable or flip out panel 316 is moved toward or into the aperture 314a and the threaded portions 330a of studs 330 (already bonded onto the surface of the flip out panel at or near the perimeter edge of the flip out panel) are received through the apertures 318a in the hinge elements 318, whereby the female fasteners or nuts 331 are threaded onto the studs 330 and tightened to secure the hinge elements to the flip out panel 316, and thus to pivotally attach or mount the flip out panel 316 to the fixed panel 314. As shown in FIGS. 14 and 16, a cover element 323 may be attached at the hinge element 318 to cover or conceal the hinge element 318 and stud 330 and nut 331 at the flip out panel 316. In the illustrated embodiment, hinge element 318 includes a lip 318c and an aperture or hole 318d, and the cover element 323 includes a lip 323a and a tab 323b for attaching to the lip 318c and aperture 318d of hinge element 318 to attach the cover element 323 to the hinge element 318. As can be seen in FIG. 16, the aperture 318d of hinge element 318 is disposed within frame portion 322, such that the tab 323b of cover element is disposed within frame portion 322 when attached to the hinge element 318. Thus, during assembly of the window assembly, the cover element 323 may be positioned at the hinge element 318 such that the lip 323a is aligned with the tab or lip 318c, whereby the cover element 323 may be moved towards the frame portion 322 and the tab 323b is received in slot 322a (and in an enlarged portion 322d of slot 322a, such as at a thicker or wider portion 322e of the frame portion such as shown in FIGS. 14 and 15) of frame portion 322 and snapped into aperture 318d of hinge element 318 to retain or secure or attach the cover element at the hinge element 318 and flip out panel 316 and thus to conceal the hinge element and fastener 330 at the flip out panel 316.

As can be seen in FIGS. 16 and 17, frame portion 322 includes a sealing portion 322f that extends over a perimeter region of flip out panel 316 when flip out panel 316 is mounted at fixed panel 314. Sealing portion 322f includes or supports a sealing element 324 (such as a bulb seal or the like) that is attached (such as via an adhesive or the like) at the sealing portion 322f of frame portion 322. As shown in FIGS. 16 and 17, the sealing portion 322f spans the gap between the perimeter edge of the flip out window panel 316 and the perimeter edge of the opening 314a of the fixed window panel 314, and the sealing element 324 engages and seals against the inner surface of the flip out window panel 316 around the perimeter of the flip out panel when the flip out panel is closed.

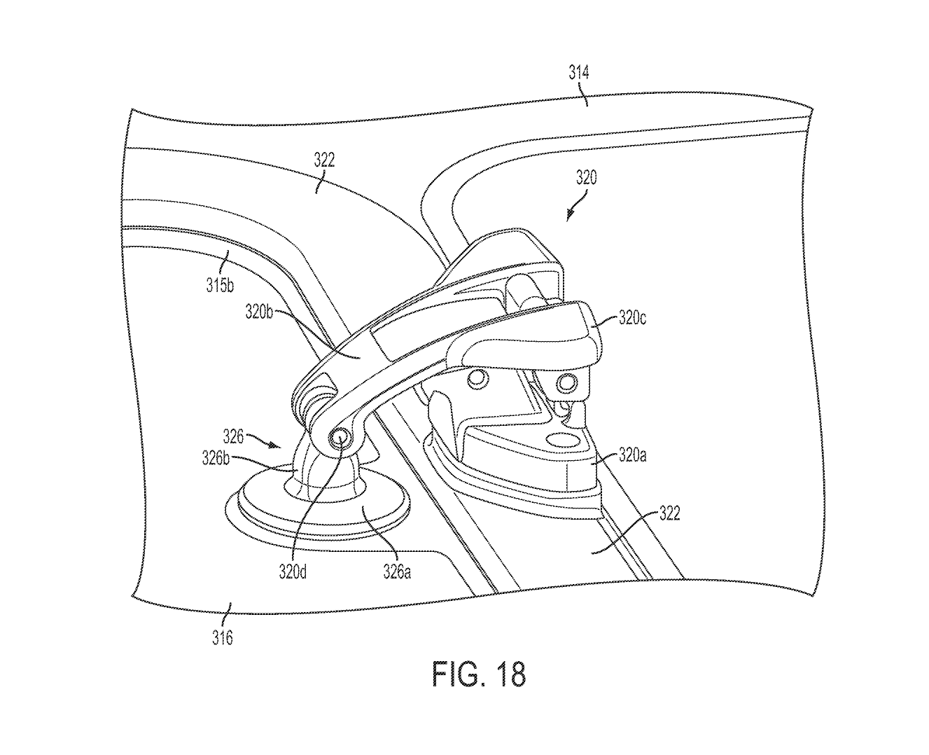

As shown in FIGS. 12 and 18, the latch or latch element or mechanism 320 is attached at or established at the frame 322 (such as via threaded fasteners or the like received in threaded inserts or the like at the frame and latch element), and comprises an articulating latch assembly that pivots and articulates to move the trailing edge of the movable window panel 316 relative to the fixed window panel 314. The latch assembly 320 includes a base portion 320a that is attached at frame 322 and/or fixed panel 314 and a pivoting latch arm 320b that is pivotally attached at a latching handle 320c that is pivotally attached at base portion 320a. Pivoting latch arm 320b is pivotally attached at a mounting portion or stud 326 attached at or near the trailing edge or end region of movable window panel 316. In the illustrated embodiment, the latch arm 320b is attached at stud 326 via a latch pin 320d so as to pivotally attach the latch arm 320b at the movable window panel 316. In the illustrated embodiment, stud 326 includes a base portion 326a and a stud or arm attaching portion 326b, with the base portion 326a adhered or bonded at the inner surface of the movable window panel 316.

Thus, during assembly of the window assembly, the base portion 320a of latch 320 is attached to the frame portion 322, such as via threaded fasteners or the like, and the frame portion 322 is adhered to the fixed panel 314, such as described above. After the hinge elements 318 are attached to the flip out panel 318, as discussed above, the latch arm 320b is attached to the arm attaching portion 326b of stud 326 via latch pin 320d to attach the trailing end region of the flip out panel 316 to the latch 320. The latch or latch assembly may comprise any suitable window latching or window actuating device or assembly, and may comprise overcenter hinges and may be manually actuated or electrically actuated to pivot the window between its opened and closed positions, and optionally may include an electrically actuated actuator or a pneumatic actuator or a cable actuator or the like to provide powered window opening and closing capabilities, such as by utilizing aspects of the window assemblies described in U.S. Pat. Nos. 7,588,652; 7,360,338; 6,871,450; 6,298,606; 6,128,860; 5,966,874; 5,704,173; and 5,551,197, which are hereby incorporated herein by reference in their entireties.

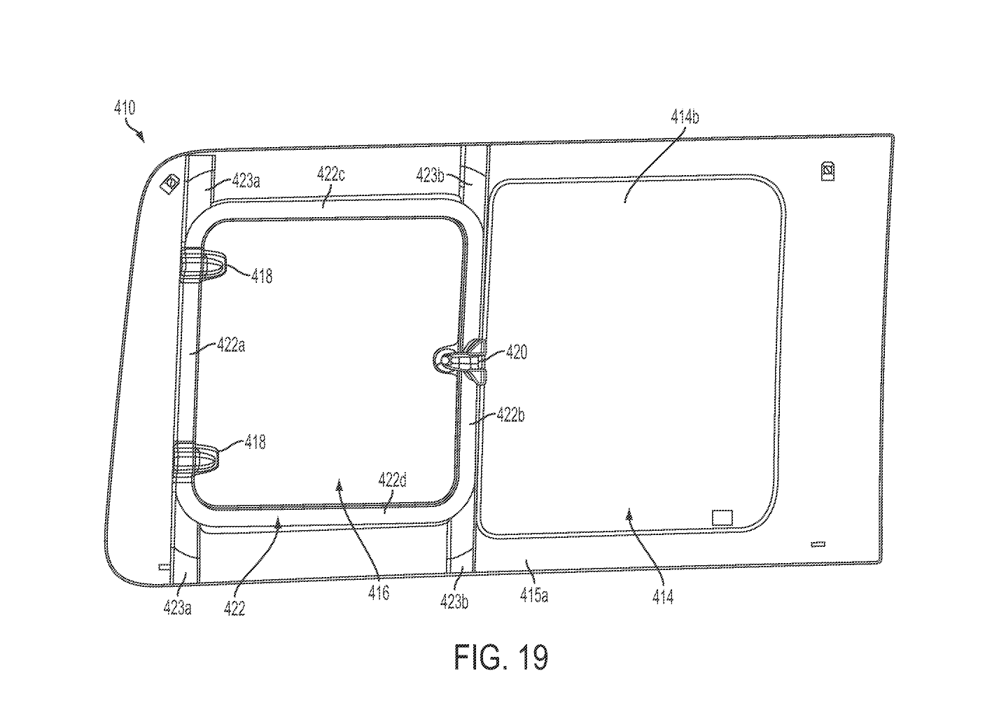

Optionally, the frame portion that extends along the periphery of the fixed glass aperture may be anchored or tethered to the vehicle body or sheet metal when the window assembly is mounted at the vehicle. For example, and with reference to FIG. 19, a window assembly 410 includes include a fixed window panel 414 and a movable or flip out window panel 416 that is pivotally mounted at the fixed window panel 414 via a pair of hinge elements 418 and a latch 420, such as in a similar manner as described above. The window assembly 410 includes a peripheral frame 422 that is attached or adhered or bonded to the fixed window panel 414 and that extends along the periphery of the aperture of the fixed glass window panel 414. The hinge elements 418 are mounted to the fixed panel 414 and/or the frame 422 (such as at a generally vertical portion 422a of the frame 422) and to the flip out or movable panel 416 and are vertically spaced apart at a pivoting portion of the window panel. The latch or latch element or mechanism 420 is mounted to the fixed panel 414 and/or the frame 422 (such as at another generally vertical portion 422b of the frame 422) and the movable panel 416 at an opposite end or region of the movable panel 416 from the hinge elements 418. The hinge elements 418 and latch 420 are bonded to the window panels 414, 416, and the frame 422 is bonded to the fixed window panel 414 and around the opening or aperture of the fixed window panel 414 at which the flip out window panel 416 is disposed, such as in a similar manner as described above.

In the illustrated embodiment, vertical frame elements 423a, 423b that extend from and/or are integrally formed with vertical frame portions 422a, 422b of frame portion 422. Frame elements 423a, 423b extend generally vertically from the perimeter frame portion 422 towards the upper and lower perimeter edge regions of the fixed window panel 414. Thus, when the window assembly 410 is normally mounted at the vehicle (such as via bonding the fixed glass panel to the sheet metal or body or trim of the vehicle or the like), the upper and lower regions of the frame elements 423a, 423b may be affixed or attached (such as via bonding or mechanical fastening or the like) to the vehicle body or sheet metal or trim or the like) to further secure or attach the perimeter frame 422 relative to the vehicle. Such an attachment structure provides enhanced securement of the window assembly and perimeter frame relative to the vehicle.

Similar to window assembly 310, discussed above, the fixed window panel 414 of window assembly 410 may have a light absorbing coating or layer 415a, such as a substantially opaque ceramic frit layer or the like, disposed about the periphery of the aperture to conceal or hide the frame 422 from view by a person viewing the window assembly from outside of the vehicle, and the light absorbing coating or layer or frit layer may be disposed substantially at the inner surface of the fixed window panel to conceal the adhesive and any vehicle trim components from view by a person viewing the window assembly from outside of the vehicle. As can be seen in FIG. 19, the opaque coating 415a may be established around a transparent or light transmitting portion 414b of the fixed panel 414 to provide a fixed transparent window portion of the window assembly (that is generally adjacent to the movable or flip out panel 416), whereby the opaque coating 415a substantially hides or conceals the inner vehicle trim and attachment structures of the vehicle from view by a person viewing the window assembly from outside of the vehicle. The movable window panel 416 may also have a light absorbing coating or layer, such as a substantially opaque ceramic frit layer or the like, disposed about the periphery of the panel to conceal or hide the sealing element and hinge elements and latch element from view by a person viewing the window assembly from outside of the vehicle, such as in a similar manner as described above.

Optionally, instead of or in addition to the frame elements 423a, 423b, the vertical frame portion 422a and/or the upper frame portion 422c of peripheral frame 422 and/or the lower frame portion 422d of peripheral frame 422 may be widened or expanded radially outward towards the respective perimeter edge regions of the fixed window panel, so as to provide for attachment of the frame portions 422a, 422c, 422d to the vehicle body or sheet metal or trim or the like, in order to further attach and secure the peripheral frame portion relative to the vehicle when the window assembly is mounted at the vehicle. The widened frame portions 422a, 422c, 422d would not be viewable by a person viewing the window assembly from outside the vehicle due to the opaque or light absorbing layer or coating at the fixed window, and may be formed to provide a finished trim appearance inside the vehicle (such as for vehicles without interior trim so as to fill in and/or cover the glass and opaque coating between the window hole or aperture and the edge of the fixed glass) or may be covered or concealed inside the vehicle via additional interior trim elements or panels of the vehicle. Optionally, the widened frame portions may extend outboard beyond the edges of the fixed glass, depending on the particular application of the window assembly. Optionally, the inboard frame portion 422b may also be widened to provide a desired appearance inside the vehicle, depending on the particular application of the window assembly.

Therefore, the present invention provides a window assembly for a vehicle, such as for the side of a vehicle, such as a van or the like, that includes a fixed window panel with a flip out window panel articulatably mounted at an opening or aperture established through the fixed window panel. Thus, to a person viewing the window assembly from the outside of the vehicle, the window assembly of the present invention provides a flush all glass window with an inner portion of the window being articulatable to open and close the flip out window. The movable or flip out window panel may be supported entirely at the fixed window panel (and/or at a frame or mounting base that extends at least partially around the aperture formed through the fixed window panel) and may not be directly supported at the vehicle sheet metal or body (although optionally the frame portion may extend to the vehicle sheet metal or body to provide further support of the window assembly and movable or flip out window panel).

Optionally, the window assembly or assemblies of the present invention may utilize aspects of the window assemblies described in U.S. Pat. Nos. 7,838,115; 7,332,225; 6,846,039; 6,319,344; 6,068,719; 5,853,895; 7,588,652; 7,360,338; 6,871,450; 6,298,606; 6,128,860; 5,966,874; 5,704,173; 5,551,197; 7,073,293; 7,003,916; and/or 6,691,464, and/or U.S. patent applications Ser. No. 11/263,221, filed Oct. 31, 2005 and published May 25, 2006 as U.S. Publication No. 2006-0107600; Ser. No. 11/948,094, filed Nov. 30, 2007, published Jun. 5, 2008 as U.S. Publication No. 2008-0127563; Ser. No. 10/454,040, filed Jun. 4, 2003 and published Feb. 5, 2004 as U.S. Publication No. 2004-0020131; Ser. No. 10/408,047, filed Apr. 4, 2003 and published Nov. 20, 2003 as U.S. Publication No. 2003-0213179, and/or Ser. No. 12/850,864, filed Aug. 5, 2010 (Attorney Docket DON02 P-1625), and/or PCT Application No. PCT/US2011/051506, filed Sep. 13, 2011 and published on Mar. 22, 20012, as International Publication No. WO2012/037190, which are all hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A window assembly for a vehicle, said window assembly comprising:
a fixed window panel having an aperture formed therethrough;
a movable window panel that is articulatably attached at said fixed window panel and is articulatable between a closed position, where said movable window panel is disposed in said aperture and is substantially coplanar with said fixed window panel, and an opened position, where at least a portion of said movable window panel is moved outward from said aperture;
wherein said movable window panel is attached at said fixed window panel via at least one hinge element at a first perimeter region of said movable window panel and a latch element at a second perimeter region of said movable window panel, and wherein said second perimeter region is opposite said first perimeter region; and
wherein said fixed window panel is configured for attaching at a vehicle structure when said window assembly is normally mounted at a vehicle.

2. The window assembly of claim 1, wherein said movable window panel is articulatable about a generally vertical pivot axis when said window assembly is normally mounted at the vehicle.

3. The window assembly of claim 2, wherein said first perimeter region comprises a leading perimeter region of said movable window panel and wherein said second perimeter region comprises a trailing perimeter region of said movable window panel.

4. The window assembly of claim 3, wherein said at least one hinge element comprises a pair of spaced apart vertically offset hinge elements that are spaced apart along said leading perimeter region of said movable window panel and that cooperate to provide said generally vertical pivot axis.

5. The window assembly of claim 1, wherein said at least one hinge element and said latch element are attached to said fixed window panel via at least one frame portion attached to said fixed window panel.

6. The window assembly of claim 5, wherein said at least one frame portion is bonded to an inner surface of said fixed window panel.

7. The window assembly of claim 5, wherein said at least one frame portion comprises a circumferential frame that is disposed around said aperture in said fixed window panel.

8. The window assembly of claim 7, wherein said at least one frame portion includes a sealing element that seals against an inner surface of said movable window panel when said movable window panel is in said closed position.

9. The window assembly of claim 8, wherein an outer surface of said movable window panel is substantially coplanar with an outer surface of said fixed window panel when said movable window panel is in said closed position.

10. The window assembly of claim 7, comprising frame portions that extend from said circumferential frame portion and towards a perimeter region of said fixed window panel, and wherein said frame portions are configured to secure said circumferential frame portion relative to a vehicle structure when said window assembly is normally mounted at the vehicle.

11. The window assembly of claim 5, wherein said at least one hinge element is disposed at an opposite side of said aperture from said latch element.

12. A window assembly for a vehicle, said window assembly comprising:
a fixed window panel having an aperture formed therethrough;
a movable window panel that is articulatably attached at said fixed window panel and is articulatable between a closed position, where said movable window panel is disposed in said aperture and is substantially coplanar with said fixed window panel, and an opened position, where at least a portion of said movable window panel is moved outward from said aperture;
wherein said movable window panel is attached at said fixed window panel via a pair of spaced apart vertically offset hinge elements that are spaced apart along a first perimeter region of said movable window panel at that attach at said fixed window panel along a first side of said aperture;
a latch element is disposed at a second perimeter region of said movable window panel and attaches at said fixed window panel along a second side of said aperture, and wherein said second perimeter region is opposite said first perimeter region; and
wherein said first side of said aperture is opposite said second side of said aperture;
wherein said fixed window panel is configured for attaching at a vehicle structure when said window assembly is normally mounted at a vehicle; and
wherein said movable window panel is articulatable about a generally vertical pivot axis when said window assembly is normally mounted at the vehicle.

13. The window assembly of claim 12, wherein said first perimeter region comprises a leading perimeter region of said movable window panel and wherein said second perimeter region comprises a trailing perimeter region of said movable window panel.

14. The window assembly of claim 12, wherein said hinge elements and said latch element are attached to said fixed window panel via at least one frame portion attached to said fixed window panel, and wherein said at least one frame portion is bonded to an inner surface of said fixed window panel.

15. The window assembly of claim 14, wherein said at least one frame portion comprises a circumferential frame that is disposed around said aperture in said fixed window panel.

16. The window assembly of claim 14, wherein said at least one frame portion includes a sealing element that seals against an inner surface of said movable window panel when said movable window panel is in said closed position, and wherein an outer surface of said movable window panel is substantially coplanar with an outer surface of said fixed window panel when said movable window panel is in said closed position.

17. The window assembly of claim 14, comprising frame portions that extend from said circumferential frame portion and towards a perimeter region of said fixed window panel, and wherein said frame portions are configured to secure said circumferential frame portion relative to a vehicle structure when said window assembly is normally mounted at the vehicle.

18. A window assembly for a vehicle, said window assembly comprising:
a fixed window panel having an aperture formed therethrough;
a movable window panel that is articulatably attached at said fixed window panel and is articulatable between a closed position, where said movable window panel is disposed in said aperture and is substantially coplanar with said fixed window panel, and an opened position, where at least a portion of said movable window panel is moved outward from said aperture;
wherein said movable window panel is attached at said fixed window panel via a pair of spaced apart vertically offset hinge elements that are spaced apart along a first perimeter region of said movable window panel at that attach at said fixed window panel along a first side of said aperture;
a latch element is disposed at a second perimeter region of said movable window panel and attaches at said fixed window panel along a second side of said aperture, and wherein said second perimeter region is opposite said first perimeter region; and
wherein said hinge elements and said latch element are attached to said fixed window panel via at least one frame portion attached to said fixed window panel, and wherein said at least one frame portion is bonded to an inner surface of said fixed window panel;
wherein said first side of said aperture is opposite said second side of said aperture;
wherein said fixed window panel is configured for attaching at a vehicle structure when said window assembly is normally mounted at a vehicle;
wherein said movable window panel is articulatable about a generally vertical pivot axis when said window assembly is normally mounted at the vehicle; and
wherein said first perimeter region comprises a leading perimeter region of said movable window panel and wherein said second perimeter region comprises a trailing perimeter region of said movable window panel.

19. The window assembly of claim 18, wherein said at least one frame portion includes a sealing element that seals against an inner surface of said movable window panel when said movable window panel is in said closed position, and wherein an outer surface of said movable window panel is substantially coplanar with an outer surface of said fixed window panel when said movable window panel is in said closed position.

20. The window assembly of claim 18, comprising frame portions that extend from said circumferential frame portion and towards a perimeter region of said fixed window panel, and wherein said frame portions are configured to secure said circumferential frame portion relative to a vehicle structure when said window assembly is normally mounted at the vehicle.
